(19) United States
(12) Patent Application Publication
(10) Pub. No.: US 2009/0282169 A1
(43) Pub. Date: Nov. 12, 2009

(54) SYNCHRONIZATION PROGRAMS AND METHODS FOR NETWORKED AND MOBILE DEVICES

(76) Inventors: Avi Kumar, Cupertino, CA (US); Nathan Hunter Calvert, Austin, TX (US)

Correspondence Address: KUWARE, INC., 1211 W. 8th St, #201, Austin, TX, 78703, US

(21) Appl. No.: 12/118,676

(22) Filed: May 9, 2008

(51) Int. Cl. G06F 15/16

(52) U.S. Cl. 709/248

(57) ABSTRACT

Mobile synchronization systems are provided for synchronizing user data objects among user devices. In one embodiment, mobile devices are provided with a synchronized environment to a user desktop, having either synchronized copies of the data objects, or a shortcut to a system peer storing the data object. Another embodiment provides priority scoring of data objects to keep the most desired objects locally on mobile devices. Another embodiment provides separate handling and prioritization for user media files. Preferably, synchronization is always-on and user transparent.

### TECHNICAL FIELD

This invention relates to data synchronization systems for mobile devices, especially ultra-mobile PC's and mobile internet devices, and particularly to such systems that provide a synchronized desktop environment or manage media files.

### BACKGROUND

There is a need for computer systems that are powerful, mobile, and wirelessly connected to the internet. For example, it can be costly to purchase and maintain a laptop computer, and a PDA for pocket-portable information access, and a cellular phone. The combined size and weight of such devices also presents a burden to many business travelers, students, and other individuals who work with digital information and need to stay connected. It can also be burdensome to learn to use many different interfaces. An internet-capable PDA or PDA/phone presents one solution, but it typically frustrates internet use due to small screen size and slow keyboard typing.

A new development in portable computing, the ultra-mobile PC (“UMPC”), provides a solution having power similar to that of a notebook compute, but portability more like that of a PDA. The UMPC screen is typically larger than a PDA screen, measuring around 4-7 inches diagonally. The UMPC is therefore portable in a smaller bag than a notebook computer, or in a large jacket pocket, but not typically in a pants pocket like a PDA or cellular phone.

Another need in the portable computer market is the need to store similar data (such as an address book) in several mobile computing devices often requires multiple entries and wasted time. Further, the need to access working files across portable devices and desktop PCs or storage area networks often creates extra tasks for information workers, for example copying files onto portable data drives or logging in to secure networks to remotely access files.

What is needed, therefore, are devices that provide computing power, wireless connectivity, and comparatively large screen size. What is also needed are devices that synchronize a users digital data among various work environments for easy portable access.

### SUMMARY

Mobile synchronization systems are provided for synchronizing user data objects among user devices. In one embodiment, mobile devices are provided with a synchronized environment to a user desktop, having either synchronized copies of the data objects, or a shortcut to a system peer storing the data object. Another embodiment provides priority scoring of data objects to keep the most desired objects locally on mobile devices. Another embodiment provides separate handling and prioritization for user media files. Various methods are provided to prioritize and synchronize user data files. Preferably, synchronization occurs wirelessly upon updates or access of the data object.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a system level diagram of a synchronization scheme according to one embodiment.

FIG. 2A is a hardware block diagram of a mobile internet device (MID) according to one embodiment.

FIG. 2B is a hardware block diagram of an ultra-mobile PC (UMPC) according to one embodiment.

FIG. 3 is a flow chart of a synchronization scheme according to one embodiment.

FIG. 4 is a flow chart of a local data object storage cutoff scheme to one embodiment.

FIG. 5 is a flow chart of a data object access scheme according to one embodiment.

FIG. 6 is a flow chart of a data object retrieval scheme according to one embodiment.

FIG. 7 is a flow chart of a local data store update process according to one embodiment.

FIG. 8 is a flow chart of a process to handle synchronization of media files and subscription media content according to one embodiment.

FIG. 9 is a block diagram of synchronization system software and data objects according to one embodiment.

FIG. 10 is a block diagram of synchronization system software and data objects according to another embodiment.

FIG. 11 is a flow chart of a high speed data object cache scheme according to one embodiment.

FIG. 12 is flow chart of a connection optimization scheme according to one embodiment.

Like reference symbols in the various drawings indicate like elements.

### DETAILED DESCRIPTION

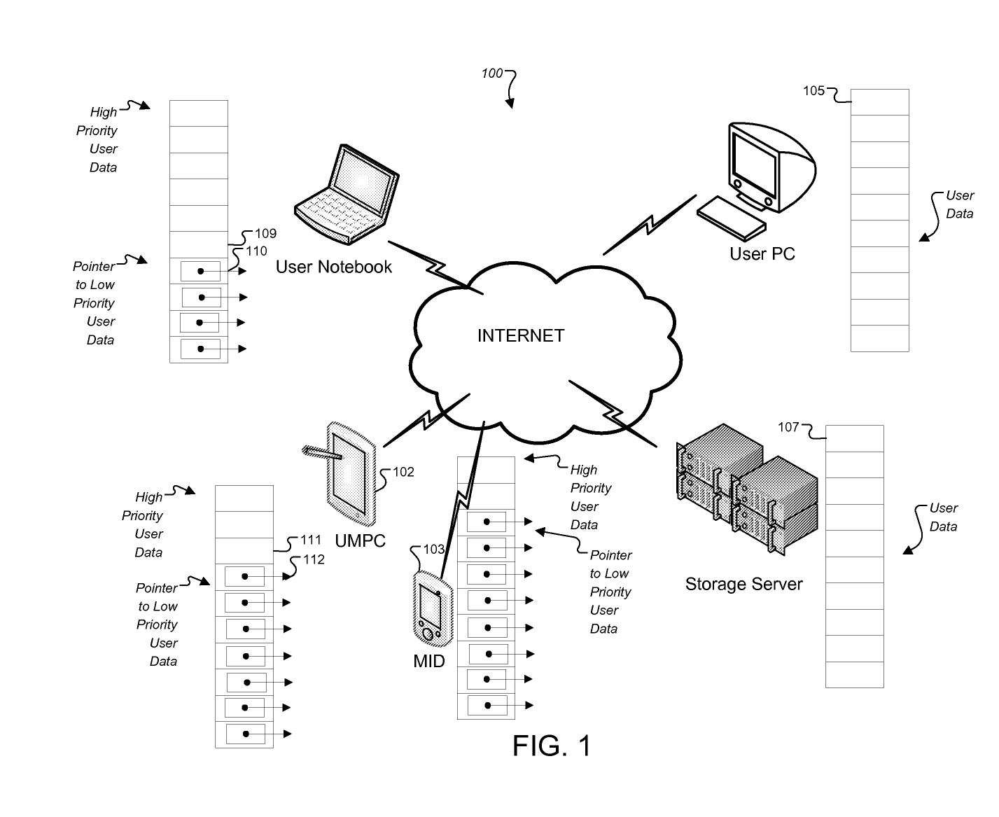

FIG. 1 is a diagram of a data synchronization system for mobile computing according to one embodiment. In the synchronization system 100, an ultra-mobile PC (UMPC) 102 having a wireless broadband connection to the internet. Also shown accessing the internet are the user's laptop, desktop PC, and a storage server. Next to each device is a representation of the user data objects stored on the device. The portable devices may have less storage and, accordingly, may not be able to store all user data. However, it is desirable at the user's laptop and ultra-mobile PC to present a desktop environment matching that of the user's PC. To achieve this on the limited-storage UMPC device 102, only high priority data is synchronized, or copied to the UMPC 102. This is represented by the data object labeled 111 and all objects above it in the depicted priority queue.

Below data object is a pointer 112, representing a network pointer or shortcut directing the UMPC software to seek the file over the internet from its original location, typically the user PC. In this manner, if a file is not present on the UMPC 102, the user may still access it seamlessly as if they were sitting at their desktop PC. The files that are chosen for storage on UMPC 102 are high priority files that the user accesses most often. These are chosen to be recently accessed files, frequently accessed files, files chosen by the user to by kept synchronized, and other high priority files.

The user data on the four depicted devices is kept synchronized. This means when data is modified that the modification is immediately transmitted, if possible, to the other devices. If no connection is present or transmission cannot be finished, a synchronization list is kept and the data is transmitted when possible. The depicted user notebook computer has more storage than the UMPC 102, and therefore is able to keep more local data and less pointers to data. The depicted storage server may be used instead of the user PC as the location designated by the pointers which stores the copy of all data in the synchronized desktop environment. A data object is not limited to user data files, but includes data objects such as email and database entries.

Also shown is a Mobile Internet Device (MID) synchronized with the other devices. MIDs personalize a new category of small, mobile consumer devices providing internet browsing, coupled with the capability to communicate with others, enjoy entertainment, and access information on-the-go. They typically have smaller screens from around 4-6 inches, and more limited on-board storage than the UMPC. They also may have simplified graphical interfaces, and have less PC-like applications. Even so, a MID may still employ file viewers to examine user data files for which it has no application to create or edit the files. The MID 103 is shown having a smaller data store, but this may not always be true. The smaller data store MID provides a synchronized data environment by using more pointers and less locally-stored data than the depicted UMPC.

The use and construction of the UMPC 102, and MID 103, as well as various synchronization schemes involving mobile devices, are further described below.

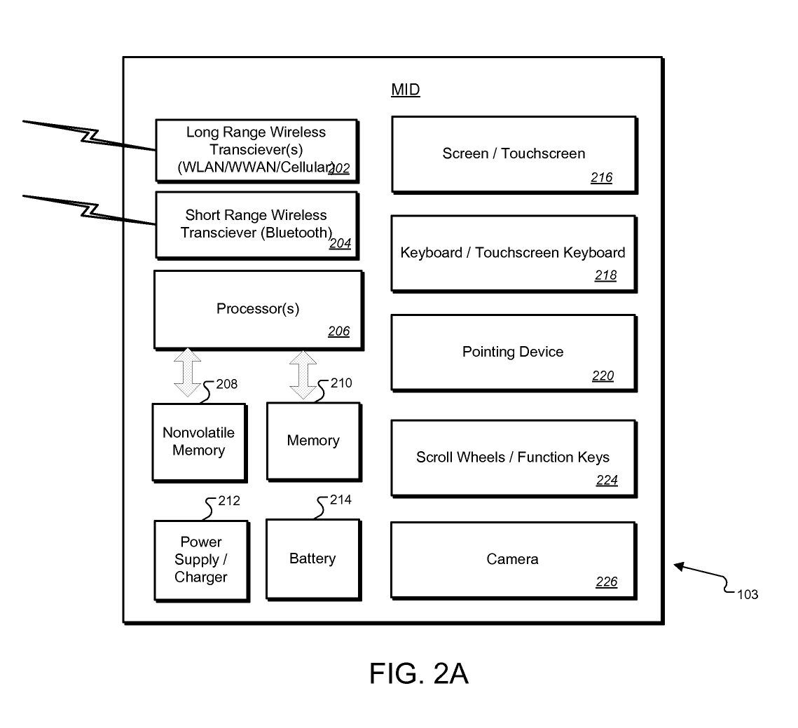

FIG. 2 depicts a high-level block diagram of the mobile internet device 103 (MID) of FIG. 1. The MID 103, as discussed above, is a mobile internet device providing connectivity, email, and entertainment. The depicted MID 103 includes a long range wireless transceiver 202 such as a cellular/3G cellular or Wi-max transceiver (these typically include a Wi-fi WLAN capability as well). It also includes a short-range wireless transceiver 204, preferably Bluetooth for communicating in a personal area network environment such as to a headset or wireless keyboard.

The preferred screen size for a MID can range from that of a UMPC screen to that of a large PDA-sized display. Such a range is typically around 4 to 7 inches, with a smaller 4-6 inch display preferred. A screen having resolution of 140-160 pixels per inch is preferred. The MID screen may be a touch screen, depending on the product and whether/what keyboard is present. Also included on a some MIDs are user I/O devices 126 such as a mousepad or mouse-nub, and various scroll wheels and function keys 224.

The processor 206 is logically connected to nonvolatile memory 208 such as, for example, a hard drive, flash drive, or hybrid drive. Processor 206 employs system memory 210 in operation.

FIG. 2B shows a hardware block diagram of an ultra-mobile PC device, general construction of which has been known in the art for over a year at the time of this filing. The depicted device 102 has a CPU 124, which may be single or multiple core processor. A presently preferred embodiment employs an Intel® A100 or A110 processor, designed for low power portable applications. Other processors may, of course, be used. The depicted chipset 202 connects to CPU 124 via the frontside bus. A preferred design is based on low-power Intel® architecture optimized for use in ultra-mobile devices, and provides an Intel® 945GU Express Chipset (202) and Intel® I/O Controller Hub ICH7 for the depicted I/O hub 204.

Chipset 202 contains a memory controller for accessing memory 128, and suitable I/O circuitry for controlling an LCD, a TV Out port, an SDVO port (Serial Digital Video Out), and a PCIE (Peripheral Component Interconnect Express) bus for communication with peripheral devices. The preferred screen size for a UMPC can range from that of an ultra-portable laptop to a large PDA-sized display. Such a range is typically around 4 to 7 inches, with a larger 6-7 inch display preferred. A screen having resolution of 140-160 pixels per inch is preferred. The UMPC screen may be a touch screen, depending on the product and whether/what keyboard is present. Also included on a typical UMPC is a devices 126 such as a mousepad or mouse-nub, and various scroll wheels and function keys 128.

A Direct Media Interface (DMI) bus connects the depicted chipset 202 and I/O hub 204. This interface is preferably a high-speed, bidirectional, point-to-point link supporting a data rate of 1 GB per second in each direction.

I/O hub 204 provides further input/output connectivity such as the parallel or serial ATA data storage interface, the audio Codec for speakers and microphone functionality, and the trusted platform module 1.2 interface supporting secure digital storage. I/O hub 204 further provides a PCI bus interface and a USB interface. A camera may be provided, as well as the Bluetooth link 122. Also provided are wireless transceiver(s) preferably providing Wi-fi WLAN capability and WWAN capability through a 3G or Wi-max long range radio.

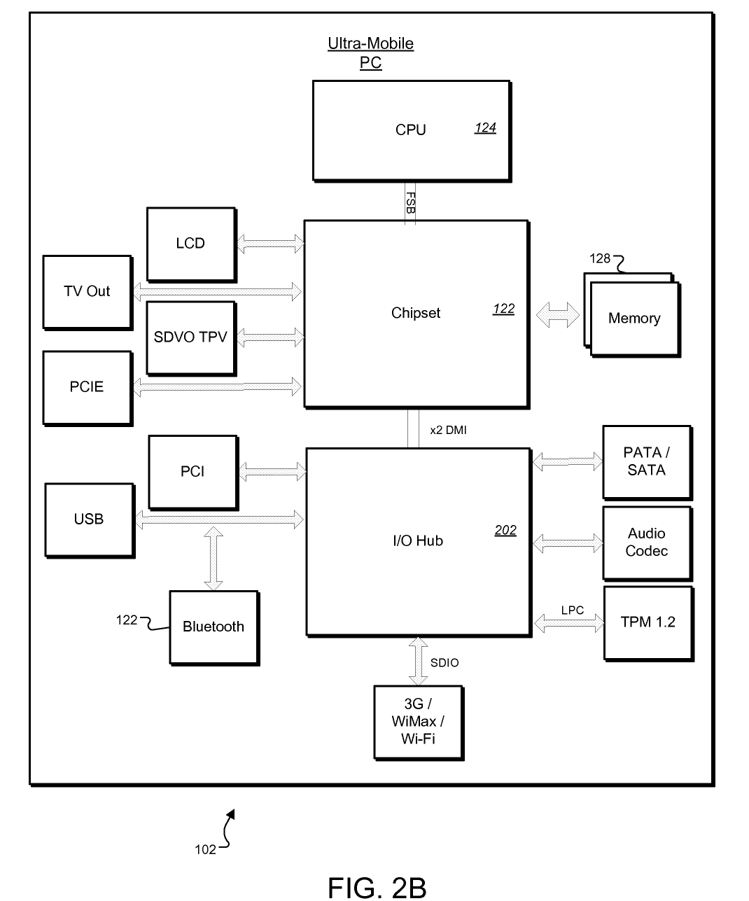

FIG. 3 is a flow chart of a synchronization scheme according to one embodiment. The depicted scheme is used to automatically synchronize data on a wirelessly-connected internet device such as a UMPC 102 or MID 103 with other user devices. The scheme is used not only on local networks such as a home wireless network, but also over the internet.

On the UMPC (or user laptop, or whatever device the user employs to edit data), the scheme uses a synchronization manager to monitor the device for modified user data files (step 302). Because many system files or application files are modified quite often, system files and application files are excluded, and only files storing user data are included in the synchronization, unless otherwise provided. The monitoring is preferably accomplished through data provided by the operating system on recently modified data files. Alternatively, lower level monitoring may monitor all files saves and filter out user data from application files and system files.

When a saved data file is detected, the system needs to synchronize the saved changes with other user devices. This task is added to a sync queue in step 304. Next, the sync manager checks to see if a network connection is present in step 306. If no connection is present, the system waits until there is one (step 308). When a connection is present, the sync manager uploads synchronization data to each connected device. The data uploaded is preferably only the file changes, and not the entire file, as is known in the art of file synchronization software. Upload may be made to all connected devices configured to locally store the data object. Non-connected devices must update after they connect to an updated device. Such changes are tracked through the synchronization queue, which is a list of synchronization tasks kept on each device and, when all devices are connected, should be identical on each device reflecting each change of a data file made by the user on any device.

Preferably, a synchronization manager communicates with its connected peers to determine if they have a pointer to the updated data object, or a locally stored copy. For devices that carry only a pointer, in step 312, the sync manager transmits only updated data object properties such as size and modification timestamp to the peer device. The pointer is thereby updated without transmitting all data modifications.

In step 314, the synchronization manager downloads synchronization data updates pending in the synchronization queue. Preferably, each of these steps is done without user interaction.

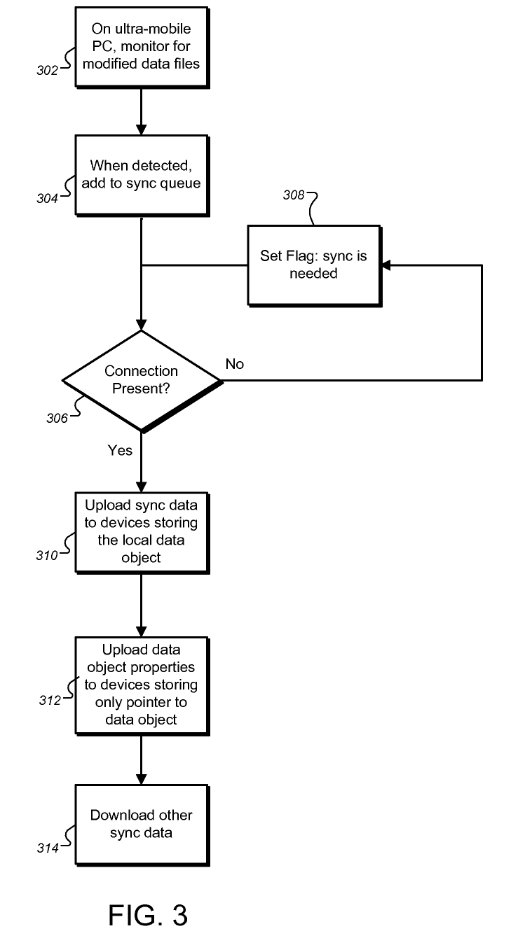

FIG. 4 is a flow chart of a mobile device synchronization process initial configuration scenario according to one embodiment. The depicted process 400 in FIG. 4 shows an example use scenario of establishing synchronization relationships between user devices. In step 402, the process starts with establishing the hierarchy between user devices. This includes designating a device as the “primary” computer, which will typically store copies of all user data objects and is intended, for the most part, to remain connected to the internet. An online data storage server may be designated rather than a user PC.

In step 404, user data is assigned an initial priority score based on a set of rules. The priority score is for use in determining whether a particular data object will be stored locally on a device with limited storage. The goal of the rules is to provide the most-used data locally, and thereby avoid delay accessing remote data. Under certain storage space conditions, the goal may be thought of, roughly, as the 80-20 rule. That is, where a portable device can only store a small portion of user data, like 20%, the synchronization scheme would store the data that is most important. Under the 80-20 rule of thumb (not always applicable), such data would cover 80% of the data needed by the user. The rules may vary among embodiments, but presently preferred embodiments have rules based on a combination of file caching theory such as purging the least recently used (LRU) and least frequently used (LFU) data, as well as user assigned priorities and data size and type. Data object priority rules will be further discussed below.

Step 406 copies the data to devices, according to whether the data has storage space sufficient to hold the data. A cutoff point is determined for each device. This may be determined by providing a preset percentage of free storage space for use as data file storage. This process preferably does not follow a typical file “caching” routine, where a small percentage of storage space is designated as a cache. The preferred embodiments use the same space for user data storage and pointer storage, not employing a separate “cache” for synchronized files, pointers, or unsynchronized files.

The synchronization proceeds in step 412 with a UMPC sync manager software module contacting its peer counterpart synchronization manager on the wireless module 104 to notify it that sync is needed. If user data was updated on the module 104 while disconnected, a similar notification may occur in the opposite direction. The devices then handshake, establish a synchronization task list, and exchange data to synchronize. This may be accomplished by synchronization procedures known in the art. A preferred synchronization procedure does not require user input to start or continue the sync process at any point. As in known synchronization procedures, only selected user data may be flagged by the sync manager for syncing when updated by the user.

In some embodiments, the long range wireless connection 106 provides internet connectivity allowing synchronization with a user PC. In such case, the user PC is provided with a synchronization manager associated with that of the UMPC 102 and wireless communications module 104. In such case, the three devices are synchronized. Preferably, the UMPC will carry the complete desktop environment of all user data to make it a true PC companion device. The wireless module 104 may hold only most frequently accessed data files, or recently accessed files, for possible viewing on the phone-sized or PDA-sized viewing area it presents. Synchronization over the long range wireless link 106 may also be accomplished with a designated storage server instead of, or in addition to, a user PC.

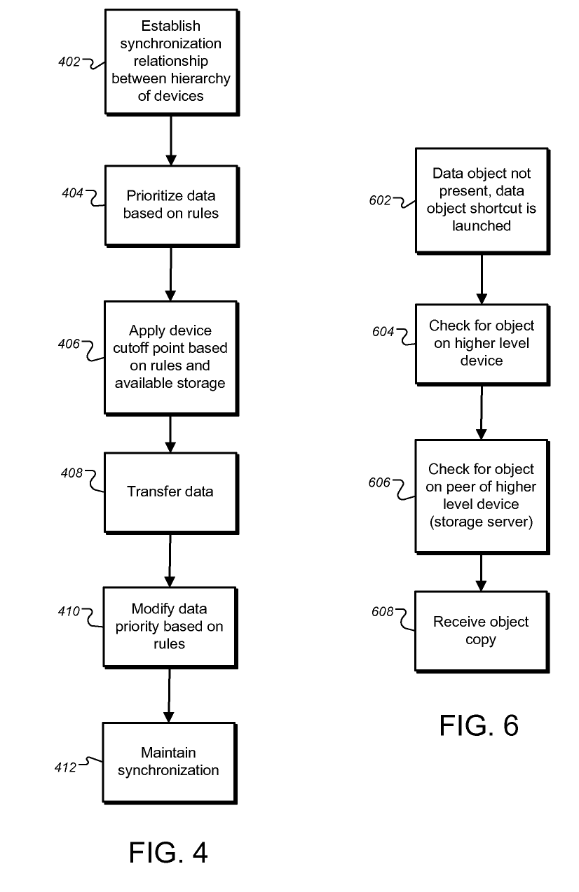

FIG. 5 is a flow chart of a peer synchronization process according to another embodiment. User data synchronization is provided in preferred embodiments to keep user data up to date on both devices, as well as to synchronize the mobile device desktop environment data with that of the user's workstation PC over the internet. Preferably, synchronization is ongoing with no command from the user.

The depicted process in FIG. 5 shows an example use scenario in which the user accesses data on a mobile device. The process begins in step 502 where the user is active with the mobile device powered on. In step 504, the user launches a particular data object to view or edit the object.

If the data object is in the local data store, at step 506, the device opens the local object in step 508. However, if the object is not in the local data store, the sync manager, the sync manager requests the object from another user device, a higher level device in the sync hierarchy such as the user PC or data server at step 510. In step 512, the sync manager receives the local copy, replaces the link with the local copy, and opens data object for user access. The sync manager next adjusts the priority setting of the object to reflect the fact that it was recently accessed (step 514). Next, in step 516, the object is synced with other objects upon save.

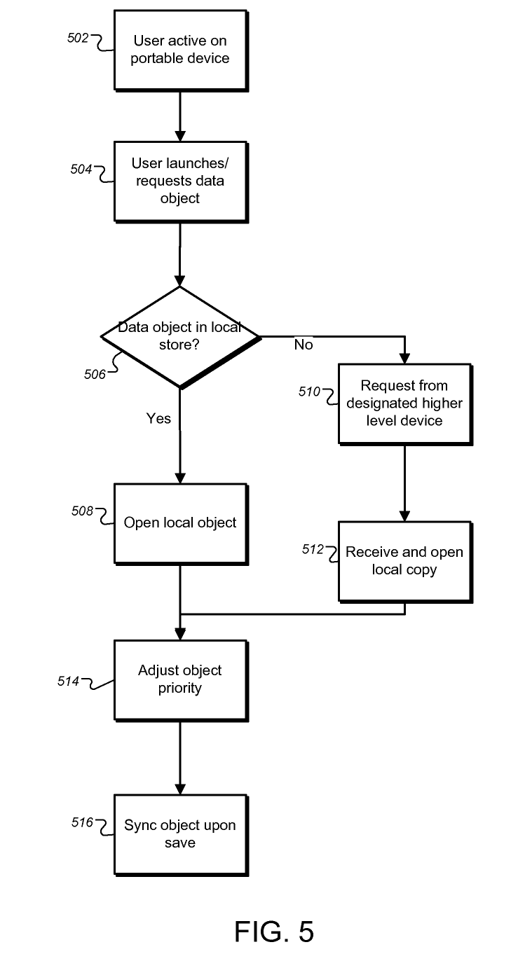

FIG. 6 is a flow chart of a process for requesting data from a synchronized device. This process may be employed for step 510 in FIG. 5, for example. The process begins at step 602 with the sync manager determining that the data object is not present, and launching the shortcut. At step 604, the sync manager uses a current hierarchy of preferred devices to choose what other synced device to request the object from, and requests the object from that device. Preferably, the current hierarchy is maintained to show the active and connected devices. If the requested device does not have the object, or is not connected, the sync manager may check for the object at a peer device to the higher level device, or a higher level device. At step 608, the sync manager receives a copy of the object.

Another embodiment may provide steps 604 and 606 simultaneously, to speed the process and provide the requested data object from the first available device.

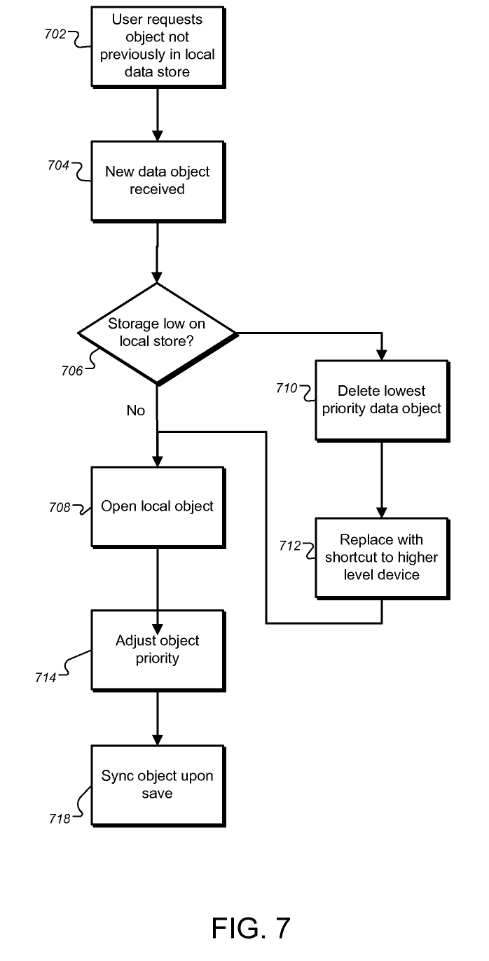

FIG. 7 is a flow chart of another synchronization process. In this process, the user requests an object not previously stored in the local data store at step 702. When the local copy of the data object is received at step 704, the sync manager checks if the storage is low on the local device at step 706. Some embodiments may allocate storage space for user data, and others may simply track the entire capacity of the local data stores, including application data. If free storage space will drop below a determined threshold, the sync manager deletes the lowest priority user data object at step 710. The lowest priority object is replaced with a shortcut at step 712, so the object is still user-accessible through the synchronized desktop environment scheme.

If the local data store is not low on free space (step 705), the sync manager proceeds directly to open the new data object at step 708. After opening, the sync manager adjusts the priority setting of the data object at step 714 to reflect the recent access. Priority setting is discussed further below. The data object is synced with other devices upon saving.

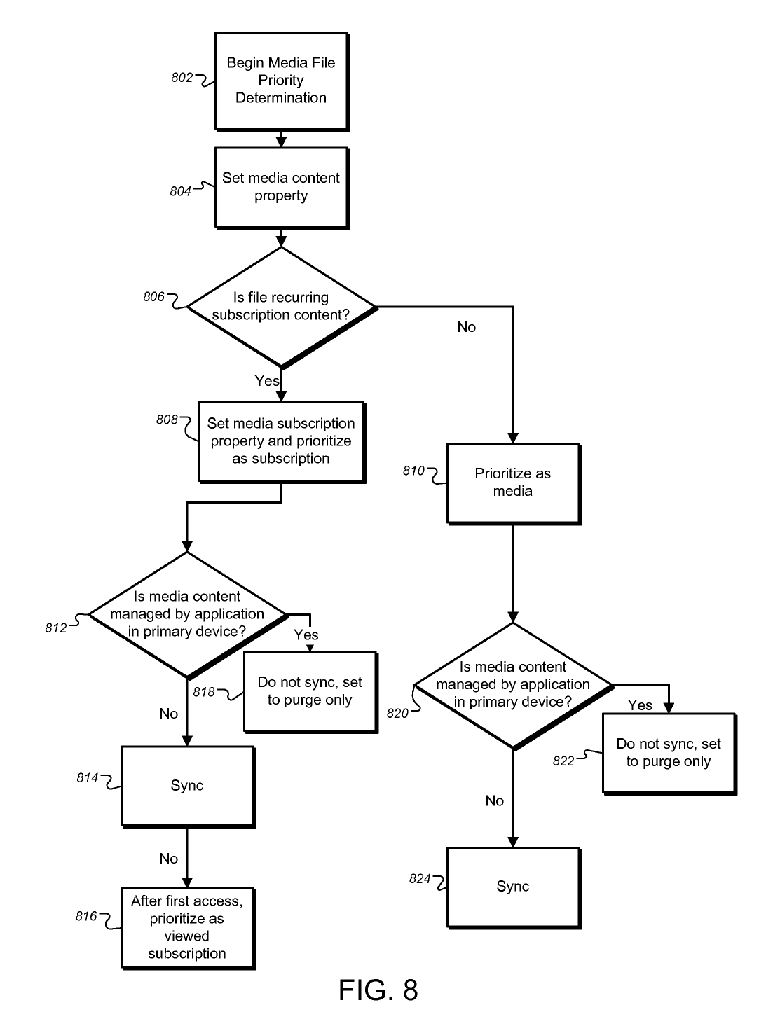

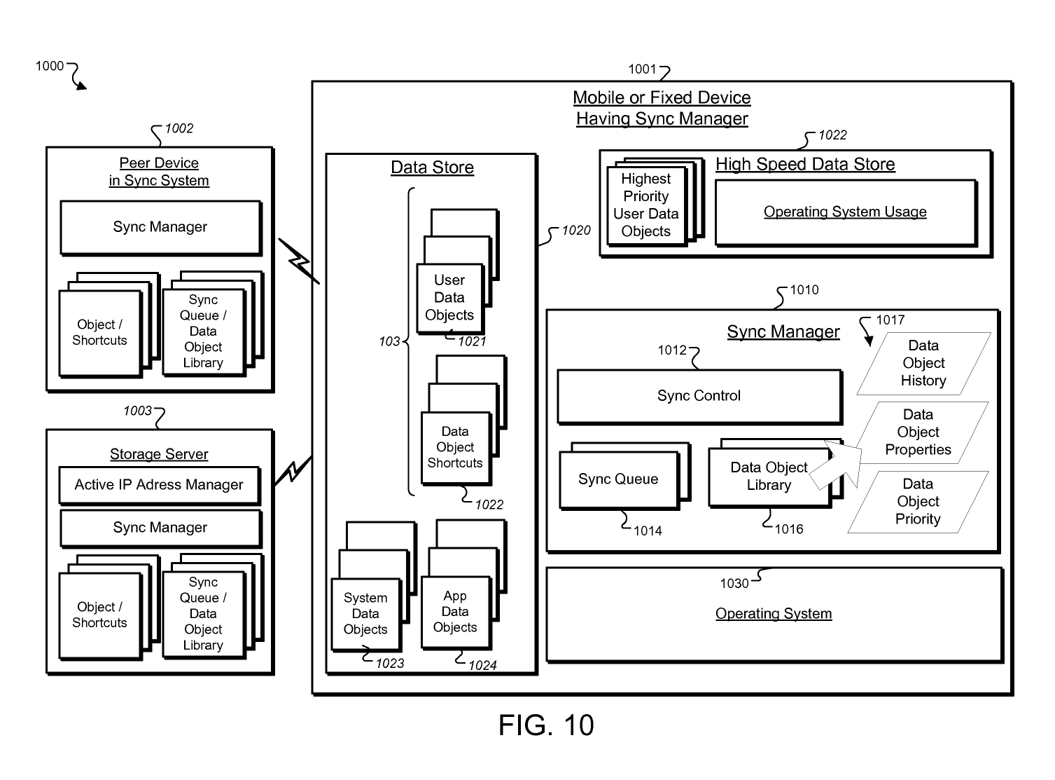

FIG. 8 is a flow chart of a synchronization process for a media file. The process begins at step 802 where a new media file is added by the user, or, more typically, downloaded through an application such as iTunes, Rhapsody, or a browser or other software through which media files might be typically downloaded. A media file is typically a digital music or video file, but may be other multimedia content such as, for example, a digital newspaper file, digital magazine, Flash multimedia file, learning object (i.e., SCORM object), or photograph. While the term “file” is used, any type of media data object may be handled, although typically media data is stored in files. The process continues at step 804, where it sets the media content property in the data object properties. These properties are described more with respect to FIG. 10. In general, media content on portable devices is preferably assigned a certain percentage of the available storage space. This helps prevent large media files from monopolizing the data object storage space over smaller user data files such as documents. In some embodiments, a separate priority list may be kept only for media files.

At step 806, the synchronization manager determines if the file is recurring subscription content, such as, for example, a podcast or digital newspaper, in which case it will be handled differently than other nonrecurring content such as, for example, a purchases song. The determination in this step may take many forms. XML tags on the media file may provide subscription information. The synchronization manager may also check the location of the file saved to see if it is one the user indicated as being a subscription-storing location, or if it is a location typically employed by the a media application to save subscription content. For example, a podcast folder in an iTunes directory probably holds subscription content. The manager may also check the number and names of data object to see if they indicate subscription content. The presence of similarly named media files with increasing numbers and regular periodic save dates may indicate media content. The subscription manager may detect the presence of any of these indicators or other suitable indicators, and any combination thereof, to determine subscription media content presence in step 806.

If the file is recurring subscription content, at step 808 the synchronization manager sets the file properties to a media content setting, and also sets a media property to indicate that the media object is a subscription object. This setting may be employed in the priority setting process, and is especially important in setting priority after the first file access.

If the file is not subscription content at step 806, the process goes to step 810, where it sets the priority of the object, considering in the priority determination the media content property setting. Setting priority will be further described below. In this process branch, the process next continues to step 820, where it determines if the media content is managed by an application on the user's primary device. For example, this step may determine that the media file is managed by the Rhapsody or iTunes programs. These programs often determine media settings such as when a particular device is licensed to play media, and when a particular media object is copied to a portable device. For example, a playlist manager for a portable device may determine when to update media files for that device. If this is the case, the user may or may not want the synchronization manager to make any changes to those files. That is, when the user's media files for a portable device are managed according to currently desired libraries or playlists, the user may wish those settings to preempt any prioritization provided by the synchronization manager. In such case, a first set of data objects would have a property set to indicate they are managed by an application. A second set would not have such a property. Step 820 may set such a property for the particular data object examined in the depicted process.

The process may make the step 820 determination in a variety of ways. A preferred process determines the type and version of media management applications employed by the user. It may also read settings of those applications to determine if the media is managed by those applications. It may also check playlist content, for example. These and other suitable indicators are used to determine whether a particular media object is managed by a media application.

If the step 820 determination is positive, the process goes to step 822, where it sets a property of the data object to indicate that it should not be synced (meaning the media manager will handle what copies are made to where). This step may also set a property to indicate that the file may be purged if object priority is sufficiently reduced. If the step 820 determination is negative, the process goes to step 824, where the data object is synced.

Referring back to step 808, if the data object considered is a subscription object, in this process branch, the process next continues to step 812, where it determines if the media content is managed by an application on the user's primary device. This step is similar to step 820. If the step 812 determination is positive, the process goes to step 818, where it sets a property of the data object to indicate that it should not be synced (meaning the media manager will handle what copies are made to where). This step may also set a property to indicate that the file may be purged if object priority is sufficiently reduced. If the step 812 determination is negative, the process goes to step 814, where the data object is synced.

A subscription data object differs from other objects in that after the first access, the user is much less likely to access it again. For example, a digital newspaper or podcast is often accessed only once. Therefore, after the first access, the synchronization manager will preferably lower the priority by a large predetermined amount (step 816). This adjustment may also be a dynamic amount determined in a variety of ways, for example by the range or distribution of priority scores among user data objects. A preferred adjustment reduces the priority to lower than other single-access media files. A typical, nonsubscription media file would have its priority score adjusted upward after an access, but in the case of a subscription file, the priority is preferably adjusted downward at step 816. Alternatively, it may be adjusted upward, but less than a nonsubscription adjustment.

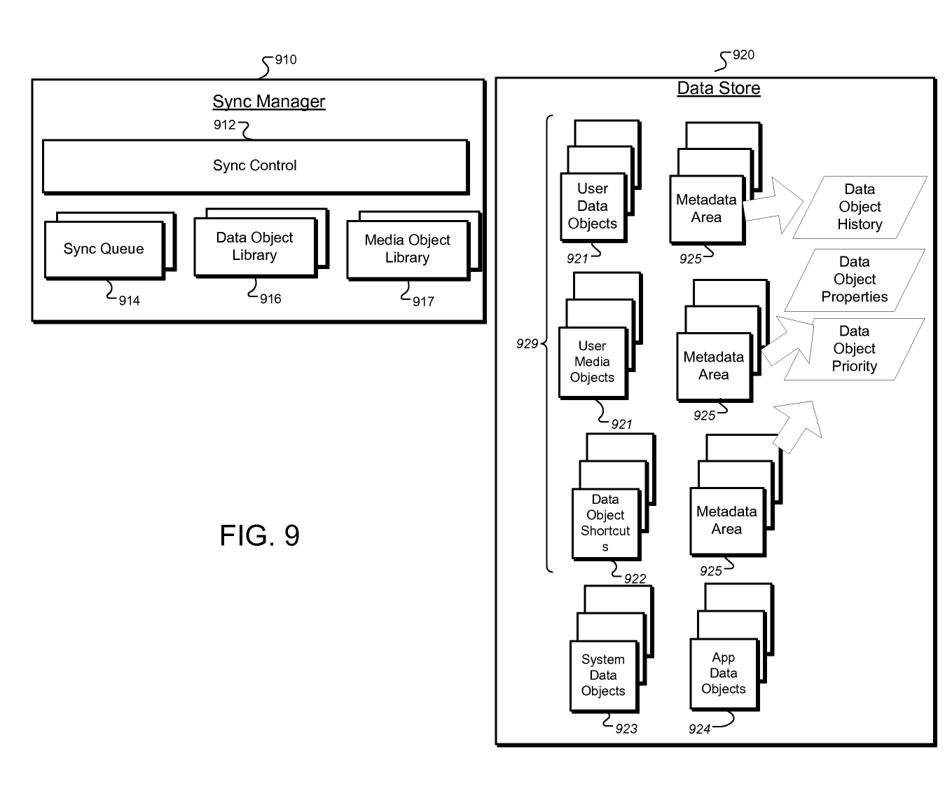

FIG. 9 is a block diagram of selected program and data objects according to one embodiment. Depicted is synchronization manager 910, which is preferably a software module installed on each device using the system herein. Also shown is a data store 920, which resides in one or more storage areas on the host device.

The sync manager includes a sync control module 912 which monitors access to data objects to provide synchronization. In this embodiment sync manager 910 has an associated synchronization queue 914. This is a data object having a list of current sync tasks that need to be performed. In this embodiment, another data object associated with sync manager 910 is the data object library 916. This data object is more complex, containing a list of all user data objects maintained for synchronization by the system.

The user data objects 921 or shortcuts 922 to those objects are stored in data store 920. Also stored are system data objects 923 and application data objects 924. The system tracks and synchronizes all of those objects designated by brackets 929, and preferably ignores the system and application data objects. For each user data object and shortcut, synchronization manager 910 maintains several data items. A Data Object History contains a history of modifications to the object, and transmits or receives to and from other devices in the synchronization system. The Data Object Properties contains indicators for several different properties that may be set. These may be flags or tags or other suitable data structures. The Data Object Priority contains the calculated priority score for use in the sync system. The sync manager may also maintain other suitable data items associated with user data objects, or groups of objects such as directories or playlists, for example.

While system data objects are preferably not synchronized, certain system objects that are needed to maintain a duplicated and synchronized desktop environment between the various user devices may be synchronized. This includes desktop.ini files or similar files containing layout of desktop, recently used items, shortcuts, and other data that is part of the user desktop experience. Browser shortcuts are preferably also synchronized.

In one embodiment, these data items are part of the data object library 916 data structure. This may be a database or list, for example. In the depicted embodiment, the data items associated with each data object are stored with the object, in a metadata area 925. Preferably, this area is provided by the operating system as a place to store metadata or tags associated with each data object. Some embodiments have metadata areas inside the files, while other have a file system providing a metadata area separate from each file but associated with the file. Preferably, this area is unlimited in size and contains tags or metadata from other applications, as well as those provided by sync manager 910. Backward compatibility may be provided with other file systems using a text file store in the same directory as the data object, the text file containing the metadata. In a preferred embodiment, the data object library data items are stored as XML tags, preferably in an XML data structures stored within the data object metadata area 925. In this manner, essential data for a data object is stored with the data object, and is not maintained in the data object library.

The depicted data objects 921 are user data objects and user media objects. As discussed above, a certain portion of storage may be allocated to media object, which may have a separate media object library 917, or may be tracked within data object library 916, but treated differently by synchronization manager 910. Each media object also has data items associated with it, just like each user data object. Similarly, data object shortcuts 922 also have data items associated with each shortcut. These are preferably synchronized between all devices in the system, and are synced to the data items associated with the actual data object pointed to by the shortcut.

As part of the synchronization process, the sync manager also synchronizes metadata associated with each data object, even if that metadata is not part of the data object, but is instead stored in a filesystem metadata area or a separate text file associated with the data object by sync manager 910.

FIG. 10 is a block diagram of a synchronization system according to one embodiment. Shown are three devices 1001, 1002, and 1003, which are synchronized in the depicted system 1000. Device 1001 shows a higher level of detail regarding the software and data objects. In this embodiment, the storage server 1003 also includes an active IP address manager. The server is preferably provided with a fixed IP address or URL such that other devices may locate it when they reconnect to the internet, or local network, after a disconnect. The IP address manager maintains a list of IP addresses for all devices currently connected, and provides the information to the peer devices, as further described below.

Device 1001 is a portable device such as a UMPC, MID, or notebook computer, for example. This device includes an operating system 1030, and a sync manager application 1010 installed therein. The sync manager 1010 includes sync control module 1012, sync queue 1014, and data object library 1016. The data object library 1016 may include one or more libraries listing media objects and data object shortcuts as well. The depicted data items 1017 may be stored in the library data structure, or as metadata associated with their respective data objects. Sync manager 1010 sets and maintains the data object priorities to determine which data is stored locally, or purged and provided as a shortcut.

Data object priority is preferably set using a cache-management style algorithm, but with some modifications. Cache management algorithms are known in the art, for example for managing web proxy caching and server caching of files in RAM versus hard drive, and other applications. Common cache management algorithms typically focus on which files to purge from the cache. In the schemes herein, the algorithm provides a score for which user data objects to store locally or replace with a pointer. A few of the most effective cache management algorithms are summarized here to provide background for their application in various embodiments of the invention.

One effective file caching algorithm is LRU (Least Recently Used), which is based on removing the least recently used resources from the cache to free up space in the cache for new requested resources.

Another algorithm is LFU (Least Frequently Used), which is based on removing the least frequently used (i.e., the least popular) resources from the cache to free up space for new requested resources. When LFU is used, preferably an LFU-Dynamic-Aging variant is used, in which an age factor is taken into account in addition to frequency of usage.

A modern file caching algorithm that takes into account the burden of managing larger files is GDS (Greedy Dual Size), or a variant GDSF (Greedy Dual Size Frequency). These are schemes in which size, effort to fetch, and popularity, and frequency of access are taken into account.

Sync managers according to various embodiments may employ any suitable file caching algorithm. Based on PC user data access patterns, an LFU algorithm may be very effective and some embodiments may use this algorithm to set priorities. (Of course, the outcome of certain algorithms may need to be “inverted” depending on whether low or high scoring files are purged in that particular algorithm.) Other embodiments may combine algorithms with a hybrid prioritization system.

In preferred embodiments of the invention, file cache management algorithms like those above are modified with other considerations relevant to user data object synchronization. First, as discussed, the sync manager tracks and synchronizes user data objects, and not application files or system files. The discussion herein on handling priority of data objects assumes that only user data objects are included. And, purging of data objects and replacing them with shortcuts is preferably only done on devices having inadequate storage space.

Next, in a synchronization context, highest weighted priority is typically those files or folders chosen by the user to be synchronized. Also, various considerations may be made to adjust the weights used in calculating priority scores, or in resolving priority of files that have similar priority scores, and are on threshold where some files must be kept, but others purged and replaced with shortcuts. Recently accessed files are given the next highest weight. Frequency of use is next. Next, size of file may be considered, a larger file should not be kept over a smaller file having similar priority. Next, the presence of an application on the mobile device to edit the data object, versus an application that may only view the object, would also cause sync manager 1010 to retain the file over one of equal priority. Also, in the context of editing on a mobile device, edited files that have not yet been synced to the other devices of course should not be deleted.

Also depicted in FIG. 10 is high speed data store 1022. Some embodiments may be provided with a high-speed data store such as a flash memory used by operating system as a high speed disk. One embodiment of a sync manager may use such a high-speed storage as a high speed cache to contain the highest-priority user files, thus speeding up the data access.

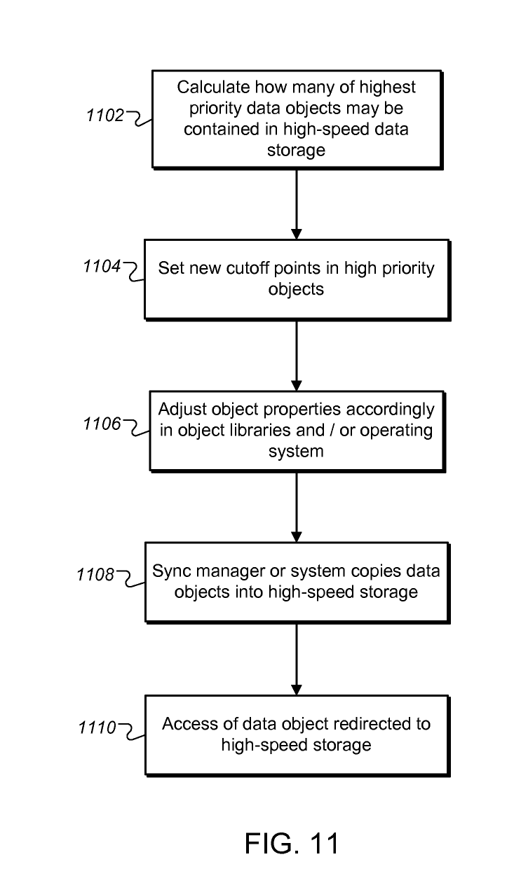

FIG. 11 is a flow chart of one process for implementing a high priority data object high speed data cache. When used, this process uses the size of the high speed data store available to the sync manager to calculate how many of the highest priority user data objects will fit in the high-speed storage (step 1102). In step 1104, the system sets or adjusts a cutoff point for high speed caching among the data objects, those objects with a higher score having their object properties set to indicate they are to be included in a high speed cache in step 1106. This step may adjust file properties in the sync manager, or the operating system or a third party software application for maintaining a high speed file cache. In step 1108 sync manager or the system copies the data object into the high speed storage. This step may include adding a shortcut in the original location, or making changes to the file system to indicate the new location of the stored data object in memory, but retain the directory path for the object. Some operating systems have file caching capability and automatically map memory storage locations to frequently accessed files to the high speed data store. The synchronization manager, in some versions, is able to adjust scores provided by the operating system to provide that the highest priority data objects according to the sync manager data priorities are stored in high speed data store 1022. Another embodiment may be used where operating system 1030 does not perform high-speed caching, and will store the highest priority user data objects in high speed data store 1022 under direction of sync manager 1010. In step 1110, the next access of the data object occurs, and the system is directed to the high-speed storage to retrieve the object.

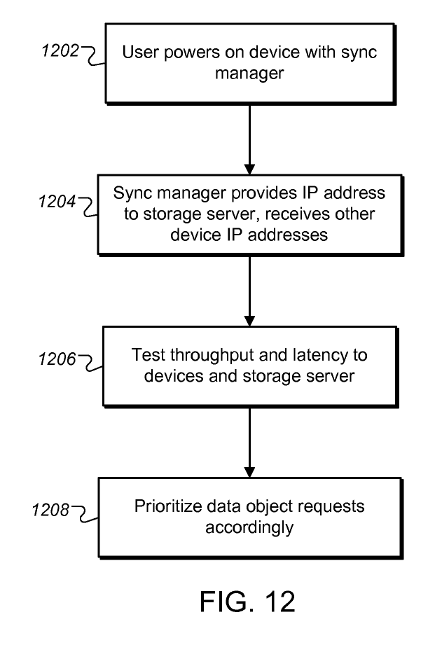

FIG. 12 is a flow chart of a connection optimization scheme according to one embodiment. In step 1202, the user powers on the device, or returns from standby or sleep mode, which activates the synchronization manager. In step 1204, the synchronization manager provides its IP address to the storage server, and requests addresses of other devices that may be connected. In step 1206, the synchronization manager tests the throughput and latency to each higher level device. The latency and throughput are analyzed to determine a best connection, which may involve adding a scaled score of throughput and the inverse of latency. Next, in step 1208, the system prioritizes data requests to request data over the best connections, in descending order. Other versions may request data objects from multiple sources at once, or may provide other priority schemes.

While various embodiments are taught herein, this specification should be interpreted to teach any operable combination or subcombination of features herein.

A number of embodiments of the invention have been described. Nevertheless, it will be understood that various modifications may be made without departing from the spirit and scope of the invention. Accordingly, other variations are within the scope of the following claims.

What is claimed is:

1. A program product stored on one or more computer readable media, the program product comprising:
first program code, on a mobile device having a broadband wireless connection, having instructions operable to monitor a file system for a newly modified data object;
second program code having instructions operable to add an identifier for the newly modified data object to a synchronization queue;
third program code having instructions operable to, following addition of an identifier for a newly modified data object, transmit, via the broadband wireless connection, synchronization data concerning the newly modified data object to an associated computer to maintain a current synchronized copy of the newly modified data object at the associated computer.

2. The program product of claim 1 further in which the third program code further has instructions operable to transmit the synchronization data concerning the newly modified data object to a second associated computer to maintain a second current synchronized copy of the newly modified data object at the second associated computer.

3. The program product of claim 1 further comprising fourth program code having instructions operable to detect a disconnection of the broadband wireless connection and, in response to detecting the disconnection, storing a synchronization task list for execution upon reconnection.

4. The program product of claim 1 wherein the third program code further has instructions operable to perform the step of transmitting synchronization data without current command from the user.

5. The program product of claim 1 further comprising synchronized desktop program code having instructions operable to provide, on the mobile device, a synchronized desktop environment to that of a designated user PC, the environment including a synchronized copy of designated high priority data files and a shortcut associated with designated low priority data files, the shortcut instructing the system to access a data store over the broadband wireless connection to obtain the low priority data file upon request.

6. The program product of claim 1 in which the third program code further has instructions operable to remove a second identifier for a least recently used data object from the synchronization queue following addition of an identifier for a newly modified data object.

7. The program product of claim 1 further comprising queue maintenance program code having instructions operable to purge the synchronization queue using a data prioritization scheme adapted to synchronize frequently used data files to the mobile device and purge identifiers of low priority data files.

8. A program product embodied on one or more computer readable media, the program product operable to reduce the perceived data access latency by a user of multiple computer devices, the program product comprising:
first synchronization program code operable to provide, on a mobile internet device (MID), a synchronized desktop environment to that of a designated user PC, the environment including a synchronized copy of designated high priority data files and a shortcut associated with designated low priority data files, the shortcut instructing the MID to access a data store over a broadband wireless connection to obtain the low priority data file upon request.

9. The program product of claim 8 in which the first synchronization program code is further operable to select the high priority data files at least partially according to a designated percentage of most frequently used data files between all synchronized environments.

10. The program product of claim 8 in which the first synchronization program code is further operable to select the high priority data files at least partially according to the availability of storage space on the MID.

11. The program product of claim 8 in which the first synchronization program code is further operable to detect a low storage space condition on the mobile device and, in response to detecting the low storage space conduction, purge a lowest priority file to create storage capacity for a newly downloaded file, and replace the lowest priority file with a shortcut.

12. The program product of claim 8 in which the high priority data files are selected, at least partially, according to a designated percentage of most frequently used data files between all synchronized environments.

13. The program product of claim 8 in which the high priority data files are selected, at least partially, according to a user configuration.

14. A program product embodied in one or more computer readable media, the program product for reducing the average data access latency by a user of multiple computer devices, the program product comprising:
first synchronization program code executable to provide, on a mobile internet device (MID), a synchronized data environment to that of a set of data stores comprising at least a first data store and a second data store, the synchronized data environment including a synchronized copy of designated high priority data files and a shortcut associated with designated low priority data files, the shortcut instructing the system to access a data store over a broadband wireless connection to obtain the low priority data file upon request.

15. The program product of claim 14 in which the first synchronization program code has instructions operable to select the high priority data files at least partially according to a designated percentage of most frequently used data files between all synchronized environments.

16. The program product of claim 14 in which the first data store is a user PC.

17. The program product of claim 14 in which the second data store is an online data storage provider.

18. The program product of claim 14 in which the first synchronization program code has instructions operable to select the high priority data files at least partially according to the availability of storage space on the MID.

19. The program product of claim 14 in which the first synchronization program code further has instructions operable to detect a low storage space condition on the MID and, in response to detecting the low storage space conduction, purge a lowest priority file to create storage capacity for a newly downloaded file, and replace the lowest priority file with a shortcut.

20. The program product of claim 14 in which the first synchronization program code further has instructions operable to select the high priority data files at least partially according to a designated percentage of most frequently used data files between all synchronized environments.
